(19) United States
(12) Patent Application Publication
(10) Pub. No.: US 2008/0145135 A1
(43) Pub. Date: Jun. 19, 2008

(54) Petroleum-based composition dispenser

(76) Inventors: Jason Scanlon, Hampton, NH (US); Craig Scanlon, Hampton, NH (US)

Correspondence Address: Jason Scanlon, 54 Glade Path, Hampton, NH, 03842, US

(21) Appl. No.: 11/638,005

(22) Filed: Dec. 13, 2006

(51) Int. Cl. B43K 5/06; B05C 17/01

(52) U.S. Cl. 401/175; 401/171

(57) ABSTRACT

The present invention encompasses petroleum-based composition dispensers, which include (a) a petroleum-based composition, (b) an opening through which petroleum-based composition is dispensed, wherein the opening has a primary axis of at least 2 cm or, preferably, at least 4 cm, and (c) a body portion. The invention provides that a user may dispense the petroleum-based composition by grasping the body portion and directly applying the composition to a desired body part, wherein hand contact with the composition is avoided. The invention eliminates the mess and need for subsequent hand washing that follows when petroleum-based compositions, such as petroleum jelly, are dispensed from conventional tubs.

### FIELD OF THE INVENTION

The field of the present invention relates to petroleum-based composition dispensers, which are particularly useful in preventing and/or treating dry skin and the other applications described herein.

### BACKGROUND OF THE INVENTION

For years, people have used petroleum jelly, e.g., Vaseline®, to treat or prevent dry skin by manually scooping the jelly from a tub and applying it to the intended body part. Such application procedure, of course, leaves residual petroleum jelly on the user's hands. This requires the user to subsequently wash his/her hands to remove the residual petroleum jelly.

Similarly, many other petroleum-based compositions, such as petroleum-based lotions and creams, are dispensed from conventional tubs, pump systems, or squeeze tubes. Such petroleum-based compositions include those that are specially designed to mitigate facial dry skin or prevent infant diaper rash. Indeed, many applications have evolved for such petroleum-based compositions. Similar to the tubs from which petroleum jelly is routinely dispensed, the pumps systems and squeeze tubs also require a user to make hand contact with the petroleum-based composition in order to apply the composition to the intended body part(s).

A limited number of petroleum-based composition dispensers are currently-available, which do not require manual application of the composition to the intended body part. Specifically, lip balms have been available for years, which allow a user to apply lip balm (a petroleum-based composition) to his/her lips without hand contact. Such lip balm dispensers, however, are relatively small. Not surprisingly, the size of lip balms are adapted to be used only in connection with a person's lips, and often comprise an application area of about 1.0-1.5 cm in length (diameter). Obviously, these so-called lip balms are not useful in applying petroleum-based compositions to larger surface areas or body parts.

In light of the foregoing, there is a need for a petroleum-based composition dispenser, which allows such composition to be applied to an intended body part, without the need for hand contact with such composition. Preferably, the dispenser is capable of quickly applying petroleum-based composition to a considerable surface area, such as a person's face or other major body parts. Still further, there is a need for a simple device that enables a user to apply a petroleum-based composition to an intended body part, wherein the device is easy to use, affordable and simple to manufacture, and, preferably, does not involve elaborate pump systems and similar dispensing means.

As the following will demonstrate, many of the foregoing needs are provided by the present invention.

### SUMMARY OF THE INVENTION

According to a first preferred embodiment of the present invention, a petroleum-based composition dispenser is provided, which comprises (i) a petroleum-based composition, (ii) an opening through which petroleum-based composition is dispensed, wherein the opening has a primary axis of at least 2 cm or, preferably, at least 4 cm, and (iii) a body portion. The petroleum-based composition dispenser includes a means for dispensing, advancing, and/or extruding the composition through the opening thereof. The invention provides that a user may dispense the petroleum-based composition by grasping the body portion and directly applying the composition to a desired body part, wherein hand contact with the composition is avoided.

According to another embodiment of the present invention, the petroleum-based composition dispenser is similar to the embodiment described above, wherein the opening consists of a top surface comprising a plurality of pores through which the petroleum-based composition is extruded and dispensed. In such embodiments, the top surface of the dispenser also comprises a primary axis of at least 2 cm or, preferably, at least 4 cm.

The petroleum-based compositions used in connection with the dispensers described herein may be conventional petrolatum-based compositions, or petrolatum-based compositions that further comprise Vitamin E, Aloe vera, or combinations thereof. In addition, the petroleum-based compositions may be designed for particular applications, such as for preventing dry skin on facial regions or diaper rash. Still further, in certain alternative embodiments, the compositions may be specially adapted to exhibit cream-like viscosities.

The invention provides that the petroleum-based compositions may be used to treat and/or prevent dry skin, sooth minor burns, protect skin from wind burns and chapping, and treat and/or prevent diaper rash.

The above-mentioned and additional features of the present invention are further illustrated in the Detailed Description contained herein. All references disclosed herein, including U.S. patents and patent applications, are hereby incorporated by reference in their entirety as if each was incorporated individually.

### BRIEF DESCRIPTION OF THE FIGURES

FIG. 1 is a cross-sectional view of a top portion of a petroleum-based composition dispenser of the present invention, which has an oval-shaped opening.

FIG. 2 is a cross-sectional view of a top portion of another petroleum-based composition dispenser of the present invention, which has a circle-shaped opening.

FIG. 3 is a perspective view of a petroleum-based composition dispenser of the present invention.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

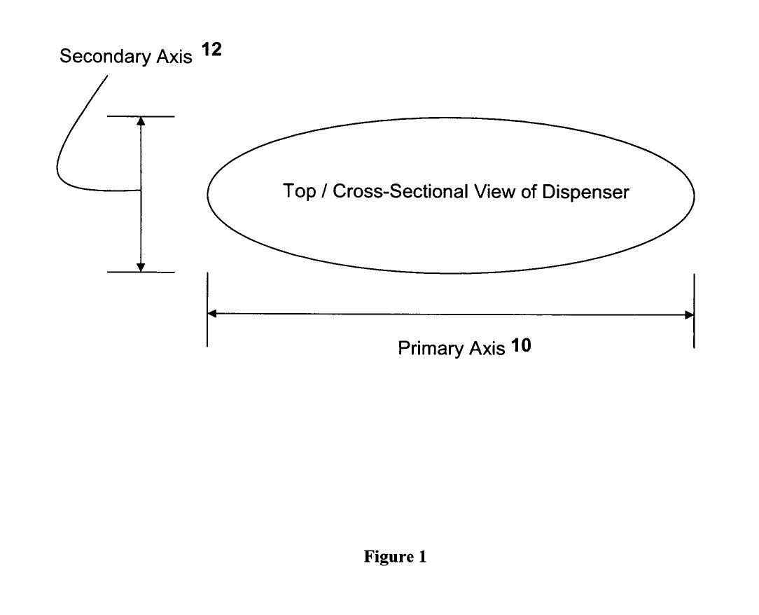

According to a first preferred embodiment of the present invention, a petroleum-based composition dispenser is provided, which comprises (i) a petroleum-based composition, (ii) an opening through which petroleum-based composition is dispensed, wherein the opening has a primary axis of at least 2 cm or, preferably, at least 4 cm, and (iii) a body portion. Referring to FIG. 1, which illustrates a top cross-sectional view of a petroleum-based composition dispenser of the present invention, the opening thereof may comprise a primary axis 10 and a secondary axis 12. In such embodiments, the opening is substantially oval-shaped, such that the primary axis 10 is longer than the secondary axis 12.

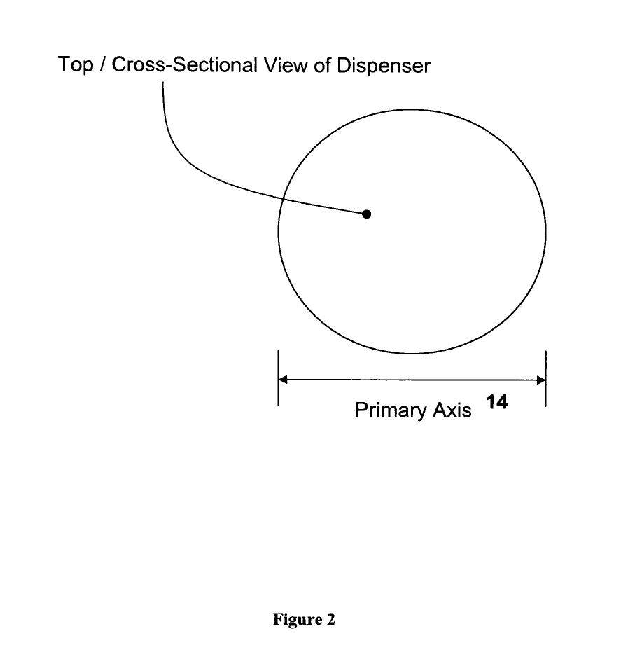

In other embodiments of the present invention, the top portion of the dispenser may have non-oval shaped configurations, such as circular, square, rectangular or other configurations. Referring to FIG. 2, for example, the top portion of the dispenser exhibits a circular cross-sectional shape, such that it has a primary axis 14 (but no secondary axis). Those of ordinary skill in the art will appreciate that any other suitable configuration may be employed for the dispensers employed in the present invention.

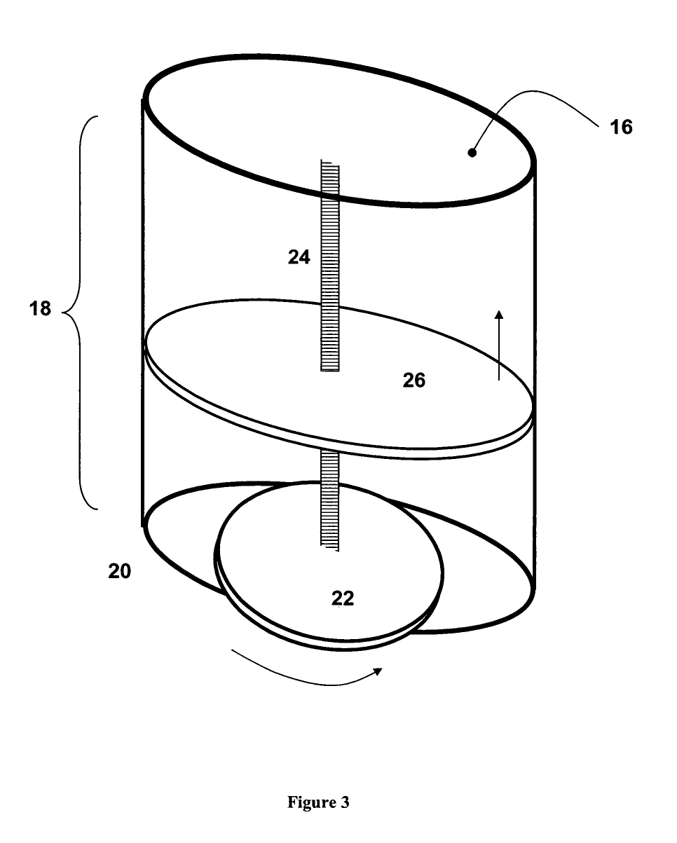

In certain preferred embodiments of the present invention, the petroleum-based composition dispenser exhibits a deodorant stick-like configuration. Referring to FIG. 3, for example, the dispenser comprises an opening 16 through which petroleum-based compositions may be dispensed, extruded, and applied. The top portion of the dispenser, near the opening 16, may be adapted to receive a cap that may be removed when petroleum-based composition is dispensed and replaced thereafter. The dispenser further comprises a body portion 18, which may be held during application of the petroleum-based composition to the intended body part.

The petroleum-based composition dispenser includes a means for dispensing, advancing, and/or extruding the composition through the opening 16 thereof. For example, the bottom portion 20 of the dispenser may comprise a rotatable knob 22 that, when rotated, engages a threaded axis 24 running within the center interior portion of the dispenser. In such example, when the knob 22 is rotated, thereby engaging the threaded axis 24, a platform 26 is advanced or pushed upward towards the opening 16 of the dispenser. The foregoing dispenser design allows petroleum-based composition to be advanced towards the opening 16 and dispensed therefrom for each application. Of course, those of ordinary skill in the art will appreciate that other dispenser configurations may be employed and, therefore, the present invention is not limited to those shown and described herein.

The opening 16 of the dispenser shown in FIG. 3 has a primary axis 10 and secondary axis 12 (FIG. 1). The primary axis 10 is preferably at least 1.5 cm or, more preferably, at least 2 cm. Still more preferably, the primary axis 10 is at least 4 cm, such as 6 cm or more. In the case of dispensers having circular openings 16, the primary axis 14 will also be at least 1.5 cm (1.8 cm² opening) or, preferably, at least 2 cm (3.1 cm² opening) or, still more preferably, at least 4 cm (12.6 cm² opening), such as 6 cm (28.3 cm² opening) or more. With respect to dispensers having non-circular openings 16, such as the dispenser shown in FIG. 3 (having an oval-shaped opening 16), the secondary axis 12 is preferably at least 1.5 cm or, more preferably, at least 2 cm. Still more preferably, in such embodiments, the secondary axis 10 may be greater than 3, 4 or 5 cm.

According to another embodiment of the present invention, the petroleum-based composition dispenser is similar to the embodiment described above, provided that the opening 16 consists of a top surface comprising a plurality of pores through which the petroleum-based composition is extruded and dispensed. In such embodiments, the top surface of the dispenser preferably exhibits the same dimensions recited above, namely, (a) a primary axis 10 of at least 1.5 cm or, preferably, at least 4 cm, such as 6 cm or more and, if applicable, (b) a secondary axis 12 of at least 1.5 cm or, preferably, at least 2 cm or more. The invention provides that dispensers having a top surface comprising a plurality of pores, wherein the top surface is displaced within and/or substantially adjacent to the opening 16 of such dispensers, may be particularly useful for dispensing petroleum-based compositions having lotion- or cream-like consistencies or viscosities. Notwithstanding the foregoing, such dispensers may advantageously be used to also dispense compositions having a wax-like or semi-solid consistency, such as 100% white petrolatum.

The invention provides that a user may dispense the petroleum-based composition by grasping the body portion 18, advancing a sufficient amount of the composition through the opening 16 thereof (and/or through a porous top surface located therein or adjacent thereto) by, for example, turning a knob 22, and directly applying the composition to a desired body part. Many advantages are provided by the present invention, such as that it allows a user to apply petroleum-based compositions to a large surface area (or major body part) while avoiding hand contact with the composition.

The petroleum-based compositions used in connection with the dispensers described herein may be conventional petrolatum-based compositions, or petrolatum-based compositions that further comprise Vitamin E, Aloe vera, or combinations thereof. In a first preferred embodiment of the present invention, the petroleum-based composition comprises at least 50% or, preferably, at least 70% or, more preferably, at least 90% petrolatum (a.ka. petroleum jelly). In certain embodiments, the petroleum-based composition is about 100% white petrolatum. The invention provides that the petrolatum employed is preferably of USP grade. Petrolatum is a well-known semi-solid mixture of hydrocarbons obtained from petroleum. There are numerous commercially-available sources of petrolatum, such as the STE Oil Company (San Marcos, Tex.). Moreover, the invention provides that the viscosity of the petrolatum employed may be adjusted to the desired level.

In a second preferred embodiment of the present invention, the petroleum-based composition may be supplemented with Vitamin E, Aloe vera extract, or combinations thereof. Vitamin E, or Alpha-tocopherol (α-tocopherol), is a fat-soluble vitamin, making it particularly amenable for combination with petrolatum. In the event that Vitamin E is used in connection with the petroleum-based compositions described herein, it is preferred that naturally-occurring α-tocopherol be utilized, insofar at such forms of Vitamin E are believed to be more active and efficiently absorbed (particularly for topical applications). For example, the petroleum-based compositions may be further provided with Vitamin E though supplementation with naturally-occurring sunflower, canola, and/or olive oils—all of which contain a-tocopherol.

In certain alternative embodiments, synthetic Vitamin E may be used (a.k.a. DL-alpha-tocopherol). Still further, the invention encompasses the use of tocopheryl acetate or tocopheryl succinate (both of which are forms that have been shown to preserve the activity of Vitamin E, thereby increasing shelf-life of the product in which the Vitamin E analog is used). In addition to its inherent anti-oxidative properties, Vitamin E is also believed to assist in preventing and/or treating sunburn, thereby making it a suitable and beneficial component of the petroleum-based compositions described herein. The petroleum-based composition may comprise 0.2-1.0% (w/v) of Vitamin E, or 1.0-3.0% (w/v) of Vitamin E, or alternatively more than 3.0% (w/v) of Vitamin E.

In another preferred embodiment, the petroleum-based compositions may further comprise Aloe vera (A. barbadensis) extracts. Aloe vera is known to be useful in the topical treatment of cuts, burns (including sun and wind burns), and eczema. Aloe vera extract is also readily available from any of numerous commercial vendors. The petroleum-based composition may comprise 0.2-1.0% (w/v) Aloe vera extract, or 1.0-3.0% (w/v) Aloe vera extract, or alternatively more than 3.0% (w/v) Aloe vera extract.

In any of the foregoing preferred embodiments, the petroleum-based composition may further comprise one or more preservatives, such as ethylenediaminetetraacetic acid (EDTA), potassium sorbate, sodium benzoate, citric acid, or combinations thereof. Such preservatives may be present, for example, at a range of 0.1-0.3% (w/v) or 0.3%-0.6% (w/v), or greater than 0.6% (w/v).

In addition, the petroleum-based compositions may be designed for particular applications, such as for preventing dry skin on facial regions or diaper rash. Still further, the compositions may be specially adapted to exhibit lotion- or cream-like textures and consistencies.

For purposes of illustration, in certain alternative embodiments, the petroleum-based composition may be specially adapted to exhibit a lotion- or cream-like consistency. For example, such compositions may include (in order of greatest percentage weight per volume) water, glycerin, stearic acid, glycol stearate, isopropyl palmitate, petrolatum, Aloe vera extract and at least one naturally-occurring vegetable oil, such as Helianthus annuus (Sunflower) seed oil (Vitamin E). Alternatively, the at least one naturally-occurring vegetable oil may be replaced by or supplemented with tocopheryl acetate (Vitamin E). Still further, such compositions may comprise one or more preservatives, such as ethylenediaminetetraacetic acid (EDTA).

In other alternative embodiments, the petroleum-based composition may be adapted for use in preventing and/or treating infant diaper rash. In such embodiments, the petroleum-based composition may comprise at least 40% petrolatum or, preferably, at least 50% petrolatum. In addition, such composition preferably comprises at least 10% lanolin, such as 15-20% lanolin. Still further, the petroleum-based composition may comprise Vitamin E, Vitamin A, Vitamin D, or a combination thereof, as well as other dermatologically-acceptable agents such as fragrance, light mineral oil, microcrystalline wax, paraffin, or a combination thereof.

The invention provides that the petroleum-based compositions may be used to treat and/or prevent dry skin, sooth minor bums, protect skin from wind bums and chapping, and treat and/or prevent diaper rash.

The present invention is particularly useful in treating light topical bums, insofar as the petroleum-based composition may be applied to the burned area, while avoiding contact between a user's hands and the burned area. More particularly, in light of the germs, bacteria, and other elements that are known to reside on human hands, such elements will not contact the burned area (which will be particularly susceptible to infection) when petroleum-based composition is applied thereto using the dispensers described herein.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A petroleum-based composition dispenser, which comprises:
(a) a petroleum-based composition;
(b) an opening through which petroleum-based composition is dispensed, wherein the opening has a primary axis of at least 2 cm; and
(c) a body portion, wherein a user dispenses the petroleum-based composition by grasping the body portion and directly applying the composition to a desired body part, wherein hand contact with the composition is avoided.

2. The petroleum-based composition dispenser of claim 1, wherein the primary axis is at least 4 cm.

3. The petroleum-based composition dispenser of claim 1, wherein the primary axis is at least 6 cm.

4. The petroleum-based composition dispenser of claim 1, wherein the opening has a primary axis ranging from 3 to 7 cm and a secondary axis ranging from 2 to 4 cm.

5. The petroleum-based composition dispenser of claim 4, wherein the composition comprises at least 40% white petrolatum.

6. The petroleum-based composition dispenser of claim 5, wherein the composition comprises at least 80% white petrolatum.

7. The petroleum-based composition dispenser of claim 6, wherein the composition further comprises Vitamin E.

8. The petroleum-based composition dispenser of claim 6, wherein the composition further comprises Aloe vera extract.

9. The petroleum-based composition dispenser of claim 6, wherein the composition further comprises a combination of Vitamin E and Aloe vera extract.

10. The petroleum-based composition dispenser of claim 6, wherein the dispenser exhibits the shape and size of a deodorant stick dispenser.

11. The petroleum-based composition dispenser of claim 1, wherein the opening is circular.

12. The petroleum-based composition dispenser of claim 1 1, wherein the opening has a cross-sectional area of at least 3.1 cm².

13. The petroleum-based composition dispenser of claim 11, wherein the opening has a cross-sectional area of at least 12.6 cm².

14. A petroleum-based composition dispenser, which comprises:
(a) a petroleum-based composition;
(b) a top surface through which petroleum-based composition is dispensed, wherein the top surface (i) has a primary axis of at least 2 cm and (ii) comprises a plurality of pores through which the petroleum-based composition is extruded and dispensed; and
(c) a body portion, wherein a user dispenses the petroleum-based composition by grasping the body portion and directly applying the composition to a desired body part, wherein hand contact with the composition is avoided.

15. The petroleum-based composition dispenser of claim 14, wherein the primary axis is at least 4 cm.

16. The petroleum-based composition dispenser of claim 15, wherein the primary axis is at least 6 cm.

17. The petroleum-based composition dispenser of claim 14, wherein the top surface has a primary axis ranging from 3 to 7 cm and a secondary axis ranging from 2 to 4 cm.

18. The petroleum-based composition dispenser of claim 14, wherein the composition comprises at least 80% white petrolatum.

19. The petroleum-based composition dispenser of claim 14, wherein the composition comprises (i) at least 40% white petrolatum and (ii) one or more agents selected from the group consisting of Vitamin E, Aloe vera extract, and combinations thereof.

20. A petroleum-based composition dispenser, which comprises:
(a) a petroleum-based composition, wherein said composition comprises (i) at least 80% petrolatum and (ii) Vitamin E, Aloe vera extract, or a combination thereof;
(b) an opening through which petroleum-based composition is dispensed, wherein the opening has a primary axis ranging from 3 to 7 cm and a secondary axis ranging from 2 to 4 cm; and
(c) a body portion, wherein a user dispenses the petroleum-based composition by grasping the body portion and directly applying the composition to a desired body part, wherein hand contact with the composition is avoided.
